(19) United States
(12) Patent Application Publication
(10) Pub. No.: US 2006/0234184 A1
(43) Pub. Date: Oct. 19, 2006

(54) Dental device

(76) Inventor: Michael Grimm, Santa Ana, CA (US)

Correspondence Address: CONNORS ASSOCIATES, 1600 DOVE ST, SUITE 220, NEWPORT BEACH, CA, 92660, US

(21) Appl. No.: 11/105,001

(22) Filed: Apr. 13, 2005

(51) Int. Cl. A61C 1/10

(52) U.S. Cl. 433/114

(57) ABSTRACT

A dental device for gripping a dental drill bit includes axially aligned collar, spreader and actuator. The actuator is manually depressed to open the device to enable a drill bit to be inserted therein. When opened, the drill bit is passed through the collar and spreader into a receptacle in the actuator. Depressing the actuator forces the spreader into expandable ends in the actuator and collar. Releasing the actuator with the drill bit inserted in the device allows the expanded ends to grasp the drill bit at two spaced apart locations.

### INCORPORATION BY REFERENCE

The inventor incorporates herein by reference any and all U.S. patents, U.S. patent applications, and other documents, hard copy or electronic, cited or referred to in this application.

### DEFINITIONS

The words “comprising,” “having,” “containing,” and “including,” and other forms thereof, are intended to be equivalent in meaning and be open ended in that an item or items following any one of these words is not meant to be an exhaustive listing of such item or items, or meant to be limited to only the listed item or items.

### BACKGROUND OF INVENTION

To do certain types of dental work, dentists use a dental hand-piece or drill that rotates at very high revolutions per minute (rpm) a drill bit, sometimes referred to as a bur. The drill bit is inserted into a chuck type dental device that grips the shaft of the drill bit and this device is detachably connected to the drill. The very high rpm of the drill bit while grinding a patient's tooth or otherwise frequently causes precession, a wobbling of the tip of the drill bit, if the drill bit is not securely attached to the drill. This unwanted wobbling decreases the cutting precision of the drill bit and often produces an increase in noise or a disturbing rattling sound. U.S. Pat. Nos. 6,155,826 and 6,190,168 illustrate typical chuck type dental devices.

### SUMMARY OF INVENTION

Briefly, the present invention decreases the amount of precession and noise, i.e., a rattling sound, of the drill bit by applying a gripping force at two locations on the drill bit.

This invention has one or more features as discussed subsequently herein. After reading the following section entitled “DETAILED DESCRIPTION OF ONE EMBODIMENT OF THIS INVENTION,” one will understand how the features of this invention provide its benefits. The benefits of this invention include, but are not limited to providing a dental device: (a) that grips a drill bit in two places along the shaft of the drill bit to reduce precession and noise; (b) that allows the dentist to change drill bits quickly and easily, and (c) that securely holds a drill bit.

Without limiting the scope of this invention as expressed by the claims that follow, some, but not necessarily all, of its features are:

One, the dental device of this invention grips an inserted dental drill bit at two spaced apart locations along the shaft of the drill bit to prevent or reduce precession and noise. It includes a housing, a collar member, a spreader member, and an actuator member axially aligned within the housing. One end of the actuator member includes a receptacle member with an expandable open end and one end of the collar is expandable, The spreader member is between these expandable ends, and upon manual actuation, the actuator member moves axially to force the spreader member to expand these ends to enable a shaft of a drill bit to be inserted into the device and held firmly by the actuator and collar members upon release of the actuator member.

Two, the housing may have an axial passageway extending between first and second opposed open ends of the housing. In one embodiment, the housing passageway is substantially cylindrical, and it may have, for example, a diameter from about 0.10 to about 0.115 inch. The actuator, spreader, and collar members each may have an external surface portion corresponding approximately in size and cross-sectional configuration to the size and cross-sectional configuration of the housing passageway, for example, cylindrical, so these members fit snug within the housing's passageway. The actuator and spreader members are, however, axially moveable along the housing's passageway, and the collar member may be fixedly attached to the housing. A proximal open end of the housing may include a restricted opening, and the actuator member may include an end portion that passes through this restricted opening and a land that serves as a stop element to limit the axial movement of the actuator member. If the housing passageway is substantially cylindrical, the spreader member has an annular outside diameter substantially equal to the diameter of the housing passageway.

Three, the spreader member may have an axial passageway configured to allow a shaft of a drill bit to pass freely between opposed open ends thereof. For use with drill bits having a cylindrical shaft, the spreader member passageway has a diameter that is substantially equal to the diameter of the shaft of the drill bit to be inserted there through. The spreader member may include opposed surfaces that interact with the actuator member and collar member when the actuator member is manually actuated to expand the internal expandable end of the collar member and to expand the expandable end of the receptacle member. These surfaces may be opposed, external tapered wall sections slanting towards each other, for example, they may each have a substantially truncated conical configuration. Each tapered wall section may have an outer peripheral end terminating at or near the internal surface of the housing passageway and form an acute angle with respect to this internal surface. These acute angles formed between the wall sections of the spreader member and the internal surface of the housing passageway may be from about 10 to about 30 degrees. The outer peripheral end of one wall section may terminate at an internal surface of the housing passageway and an outer peripheral end of the other wall section may be offset inward from the housing passageway's internal surface to form a step in the spreader member.

Four, the collar member has an axial passageway extending between opposed, outer and inner open ends of the collar member. For use with drill bits having a cylindrical shaft, the collar member passageway has a diameter that is substantially equal to the diameter of the shaft of the drill bit to be inserted there through. The collar inner open end may be proximate one surface of the spreader member, and this end may have a flexible and resilient wall segment forming a spring mechanism having a predetermined strength. This collar wall segment may function as a leaf spring, having a first position that restricts the collar member passageway to prevent a drill bit from passing there through and a second flexed position that expands the collar member passageway to allow a drill bit to pass through the collar member passageway. The collar member may be detachably connected to the housing.

Five, the actuator member may include a receptacle terminating in an open end that is proximate the adjacent wall section of the spreader member. The actuator member may include a flexible and resilient wall segment forming a spring mechanism having a predetermined strength that is less than the strength of the collar member spring mechanism. This actuator wall segment may function as a leaf-spring, having a first position that restricts an open mouth of the actuator member receptacle to prevent a drill bit from extending substantially into the receptacle and a second flexed position that expands the open end of the receptacle to allow a drill bit to extend substantially into the receptacle. For use with drill bits having a cylindrical shaft, the receptacle has a diameter that is substantially equal to the diameter of the shaft of the drill bit to be inserted therein.

Six, the actuator member may have an outer, proximal end projecting outward from the housing to enable the actuator member to be manually pushed into the housing to advance the actuator member inward a predetermined distance. This predetermined distance may be from about 0.010 to about 0.040 inch. As the actuator member advances its inner end engages the nearby surface of the spreader member to move the actuator wall segment into the second position to expand the receptacle to allow a drill bit to be inserted therein. The actuator member also advances the spreader member to engage the inner end of the collar member and the adjacent surface of the spreader member to move the collar member wall segment into its second position to expand the collar member passageway. This allows a drill bit to be inserted through the passageways of the collar and spreader members and into the receptacle. Upon release of the actuator member with a drill bit inserted therein, the spring mechanism of the collar member first pushes the spreader member and the actuator member towards the proximal end of the housing. The collar member wall segment bears against one portion of the shaft of an inserted drill bit and then the spring mechanism of the actuator member pushes the actuator wall segment to bear against another portion of the shaft of an inserted drill bit. The spring mechanism of the actuator member also further advances the actuator member towards the proximal end of the housing. Consequently, an inserted drill bit is held firmly in the device.

Seven, the spring mechanisms of both the actuator and collar members may comprise a plurality of prongs that may include protrusions that grip the shaft of the inserted drill bit. The prongs typically are rigid, but flexible and resilient, so they can store mechanical energy when flexed, and then use this stored energy to grip securely a drill bit and to return the spreader and the actuator members to their starting positions prior to inserting a drill bit into the device.

These features are not listed in any rank order nor is this list intended to be exhaustive.

### DESCRIPTION OF THE DRAWING

One embodiment of this invention, illustrating all its features, will now be discussed in detail. This embodiment depicts the novel and non-obvious dental device of this invention as shown in the accompanying drawing, which is for illustrative purposes only. This drawing includes the following figures (Figs.), with like numerals indicating like parts:

FIG. 1 is a perspective view of the dental device of this invention.

FIG. 2 is a side elevational view of the dental device of this invention.

FIG. 3 is cross-sectional view taken along line 3-3 of FIG. 2.

FIG. 4 is an exploded, left-hand perspective view of the dental device of this invention shown in FIG. 1.

FIG. 5 is an exploded, right-hand perspective view of the dental device of this invention shown in FIG. 1.

FIG. 6A is cross-sectional view of the dental device shown in FIGS. 1 and 3 with its actuator member manually depressed to open the device to allow the shaft of a drill bit to be inserted into the device.

FIG. 6B is a cross-sectional similar to that of FIG. 6A with the shaft of a drill bit partially inserted.

FIG. 6C is a cross-sectional similar to that of FIG. 6A with the shaft of a drill bit fully inserted and the actuator member released.

FIG. 6D is a cross-sectional similar to that of FIG. 6A with actuator member manually depressed to open the device to allow the shaft of a drill bit to be removed and the drill bit partially removed.

### DETAILED DESCRIPTION OF ONE EMBODIMENT OF THIS INVENTION

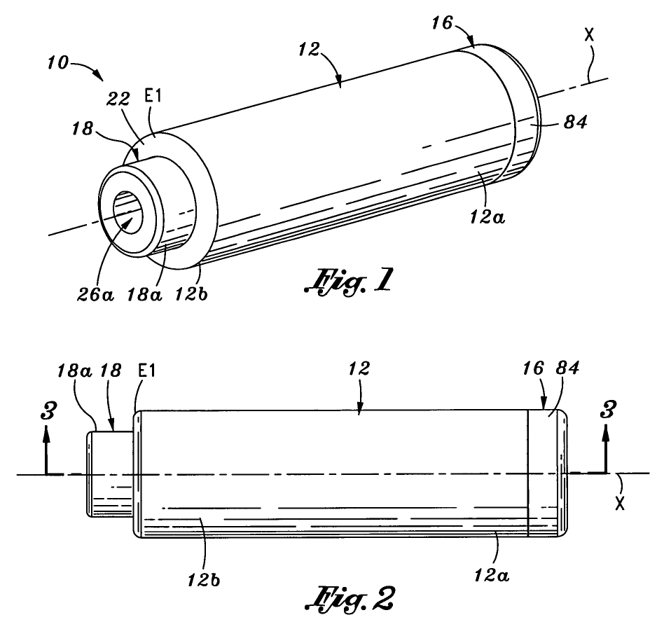

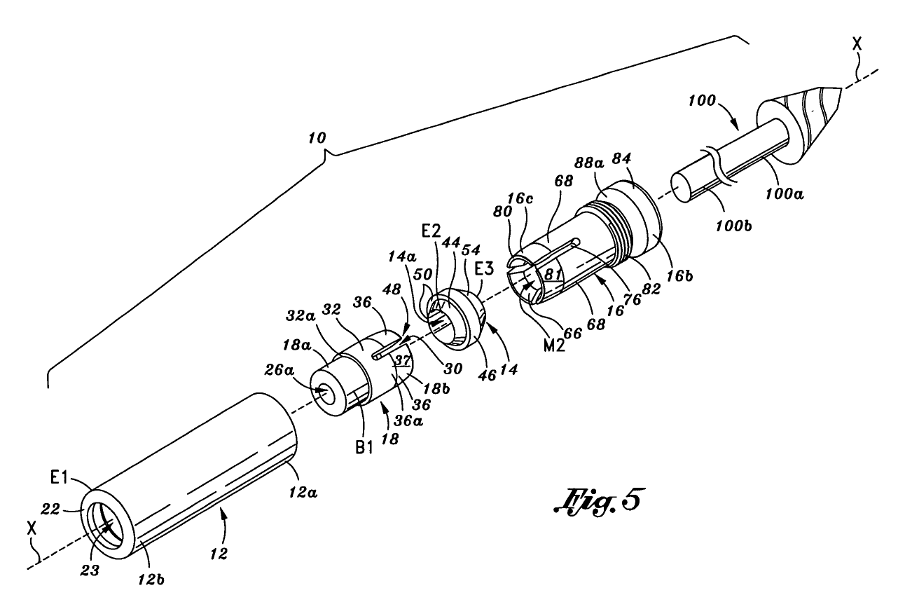

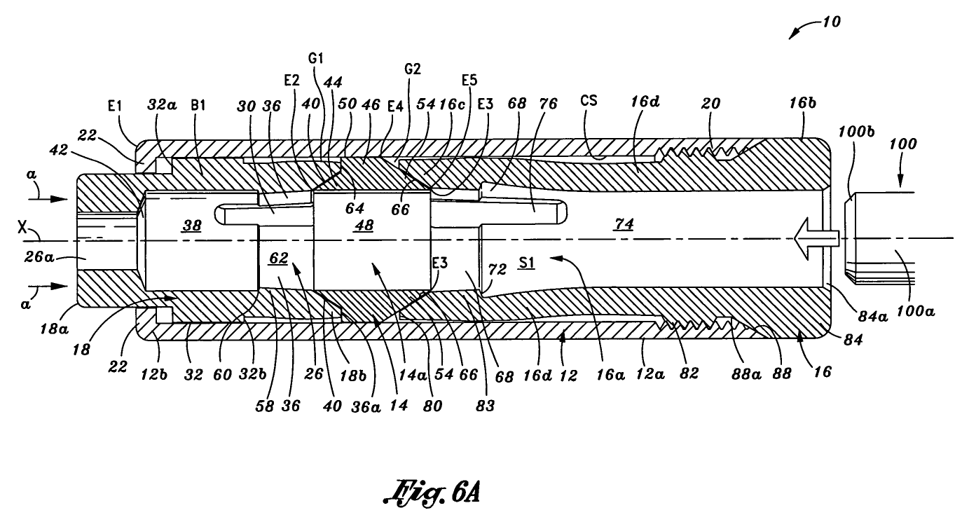

As best depicted in FIGS. 4 and 5, one embodiment of this invention is the dental device 10, which is substantially symmetrical about its longitudinal axis X. This device 10 includes a hollow housing 12, a collar 16 fixedly (but detachable) connected to a distal end 12a of the housing, an actuator 18 having a proximal end portion 18a projecting outward from a proximal end 12b of the housing, and a spreader 14 positioned between the actuator and the collar. The actuator 18 and collar 16 fit, at least partially, within the housing 12, and the spreader 14 fits completely within the housing. The respective axes of each of these components are co-extensive with the longitudinal axis X of the device 10. The housing 12, the spreader 14, the collar 16 and the actuator 18 are all separate components that may be completely detached from each other as depicted in FIGS. 4 and 5. The dentist will not normally have any need to take the dental device 10 apart because both the insertion and the removal of the various drill bits is done with the dental device 10 in its assembled state shown in FIGS. 1 through 3. These various components of the device 10 are made of stainless steel and may be formed by conventional mechanical and electrical discharge machining (E. D. M.) techniques.

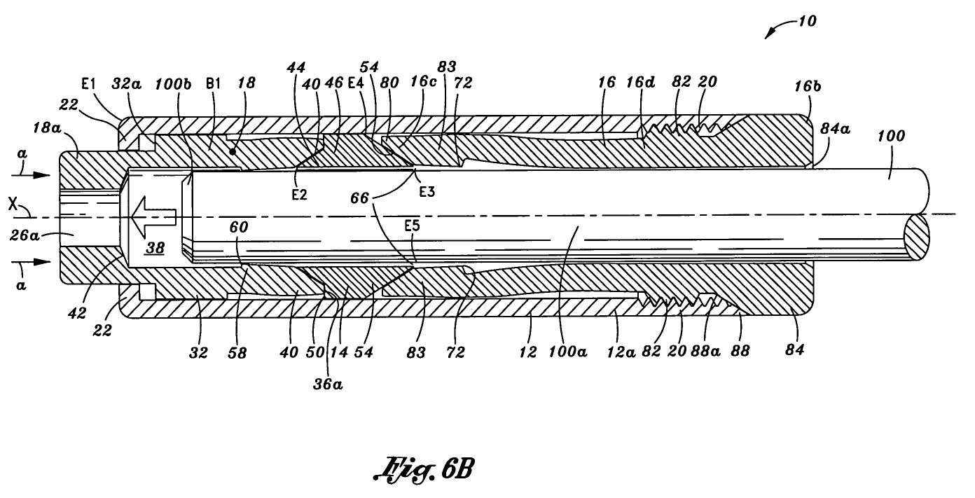

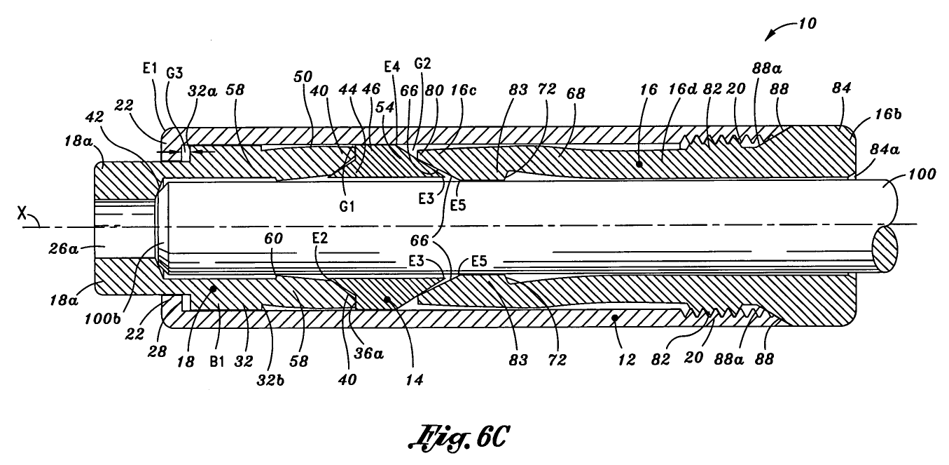

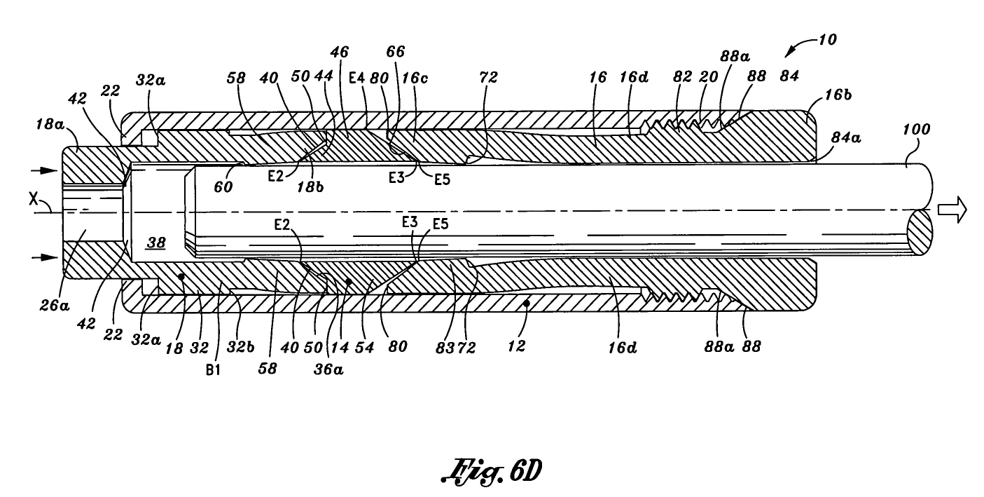

As illustrated in FIG. 6A, manually depressing the actuator's proximal end portion 18a, opens the device 10. Specifically, moving the actuator 18 inward first expands a receptacle 26 in a receptacle end 18b of the actuator 18, and next pushes the spreader 14 towards the collar 16 to expand a passageway 16a in the collar 16. This enables a dental drill bit and the like, for example a drill bit 100, to be inserted into the dental device 10, first through the collar 16, then along a passageway 14a in the spreader 14 (FIG. 6B), and finally into the receptacle 26 of the actuator 18. With the shaft 100a of the drill bit 100 completely inserted into the device 10 as shown in FIG. 6C, the actuator's proximal end portion 18a is released and the expanded receptacle 26 and collar 16 spring closed, gripping the shaft 100a at two spaced apart locations along the shaft.

The housing 12 is a substantially cylindrical tube open at its opposed ends 12a and 12b, which are joined by an internal cylindrical surface CS (FIG. 4) of the housing. The housing 12 typically has an outside diameter of from about 0.125 to about 0.140 inch, an inside diameter of from about 0.100 to about 0.115 inch, and a length from about 0.400 to about 0.600 inch. The end 12a has an inwardly tapering annular wall 88, and at this end 12a is an internal threaded surface 20. As shown in FIG. 5, at the end 12b is an annular lip 22 that is a substantially flat, ring like member with the axis X intersecting the center of a circular opening 23 in the lip. The lip 22 is substantially perpendicular to a sidewall 12a of the housing 12, extending radially inward about 0.030 inch from an outer edge E1 at the end 12b of housing 12, thus leaving the lip opening 23 with a diameter from about 0.06 to about 0.09 inch, depending on the outside diameter of the housing. This lip opening 23 is equal to, or slightly greater than, the diameter of the proximal end portion 18a of the actuator 18, which in this embodiment is cylindrically shaped. The lip 22 acts as a stop element to prevent the actuator 18 from exiting the housing 12 at the end 12b, while at the same time allowing the actuator's proximal end portion 18a to extend outward beyond the end 12b of the housing 12 through the lip opening 23.

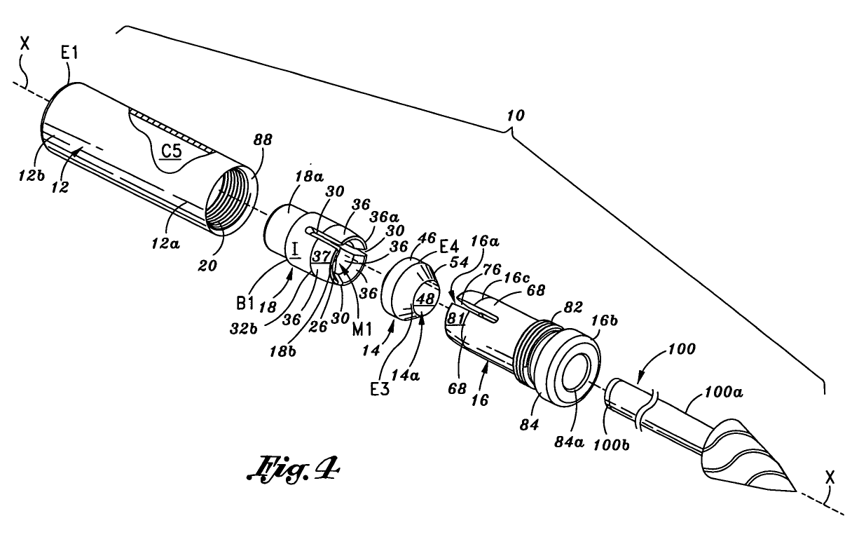

The actuator 18 comprises a tubular, generally cylindrical shaped body B1 (FIG. 4) having an annular gripping land 32 (FIG. 6A) adjacent the proximal end portion 18a and a plurality of longitudinal slits 30 (in this embodiment three at 120 degrees apart). When the device 10 is in the closed position shown in FIG. 3, one end 32a of the gripping land 32 engages the internal surface of the lip 22. The longitudinal slits 30 pass through the other end 32b of the gripping land 32, extending from the receptacle end 18b into land 32. The land 32 has an external diameter approximately equal to the inside diameter of the housing 12. This allows the actuator 18 to slide into the housing 12 easily, yet is snug enough that the actuator is laterally secure and essentially free of wobbling during rotation within the housing 12.

The proximal end portion 18a of the actuator 18 is a cylindrically shaped protrusion that extends outward from the land 32 through the opening 23 in the annular lip 22. This end portion 18a may be solid, or it may have in the opening 26a that is in communication with the receptacle 26 that extends along the axis X. The outside diameter of the proximal end portion 18a is less than the diameter of the land 32 and is equal to or slightly less than the diameter of the lip opening 23. Other embodiments may use more or less actuator slits 30 than the three depicted in this embodiment. All the slits 30 are equal in length and width and each slit has a length from about 0.06 to about 0.18 inch and a width from about 0.010 to about 0.016 inch. Each slit 30 extends through the entire thickness of the tubular body B1 (FIG. 4). These longitudinal slits 30 form equally spaced-apart fingers or prongs 36 in a sidewall of the body B1, each terminating at a tip 36a that points inward towards the spreader 14. Each prong 36 is flexible and resilient to function as a leaf-spring, which will be discussed in greater detail subsequently. As best seen in FIG. 4, the outside surface 37 at the tip 36a of each actuator prong 36 has a slight inward curve, making each actuator prong 36 thicker at its base near where it passes through the end 32b of the land 32. Thus, each prong 36 becomes thinner as it approaches the receptacle end 18b. An end 64 (FIG. 6A) of the each tip 36a is flat and substantially perpendicular to the axis X.

As depicted in FIG. 3, the receptacle 26 within the actuator 18 has a substantially cylindrical shape, terminating in either a closed bottom or, as shown, an open bottom including the opening 26a. As illustrated in FIG. 6A, the inside surface 38 of the actuator 18 has three deviations therein that prevent it from being a perfect cylindrical surface. The first such deviation is located in the proximal end portion 18a of the actuator 18 and comprises a conical transition wall 42 sloping inward from the inside surface 38 towards the opening 26a (FIG. 5). The slope of the transition wall 42 is such that it matches the slope of the end 100b of a shaft 100a the drill bit 100. The second deviation comprises a gripping step 58 (FIG. 6A) forming a slight inwardly protruding annular segment on an inside surface of each prong 36 near the prong's tip 36a. Each gripping step 58 has an inside ledge 60 that extends perpendicularly to the axis X and an inside surface 62 that is substantially parallel to the axis X. The third deviation comprises a tapered wall 40 extending from the inside surface 62 to the tip 36a of each prong 36. The tapered wall 40 of each of the three prongs 36 each slope outward to terminate in an open mouth M1 (FIG. 4) at the receptacle end 18b of the actuator 18. In this embodiment, the slope of each wall 40 is approximately 20 degrees. The open mouth M1 prior to inserting the drill bit 100 into it has a diameter that is less than the diameter of the shaft 100a of the drill bit.

As depicted in FIGS. 3, 4 and 5, the spreader 14 comprises an annular central body 46 and a pair of conical sections: a receptacle spreader section 44 and a collar spreader section 54. The spreader sections 44 and 54 straddle the annular central body 46 and are integral therewith and point in opposite directions as shown in FIG. 6A. The internal passageway 14a of the spreader 14 is slightly larger than the diameter of the shaft 100a of the drill bit 100. The external diameter of annular central body 46 is approximately equal to the internal diameter of the housing 12. As viewed in FIGS. 6A though 6D, a left-hand terminal edge E2 of the receptacle spreader section 44 is circular in shape and defines one open end of the passageway 14a, and a right-hand terminal edge E3 of the receptacle spreader section 44 is circular in shape and defines the other, opposed open end of the passageway 14a. The inside surface 48 of the spreader passageway 14a is cylindrical. From the edge E2 the receptacle spreader section 44 slopes away from the axis X towards the annular central body 46, terminating at the annular central body 46 at a point inward towards the axis X to form a ledge 50 that is perpendicular to the axis X. From the edge E3 the collar spreader section 54 slopes away from the axis X towards the annular central body 46, terminating at an edge E4 of annular central body 46. Unlike the receptacle spreader section 44, the collar spreader section 54 is not displaced inward towards the axis X, but rather its surface slope continuously all the way to the edge E4 of the annular central body 46.

As depicted in FIGS. 4 and 5, the collar 16 is a tubular structure of cylindrical shape with opposed open ends 16b and 16c at the opposed ends of its passageway 16a. Like the actuator 18, the collar 16 includes three longitudinal slits 76 equally separated at 120 degrees in a sidewall 16d of the collar 16, thus creating three flexible and resilient collar fingers or prongs 68 that each function as leaf-spring. Each slit 76 extends through the entire thickness of the collar sidewall 16d and each slit projects inward along the collar sidewall from a tip 80 of each prong 68. All the slits 76 are equal in length and width and each slit has a length from about 0.060 to about 0.180 inch and a width from about 0.010 to about 0.016 inch. The tip 80 of each collar prong 68 is substantially flat and substantially perpendicular to the axis X as shown in FIG. 6A. As best be seen in FIGS. 5 and 6A, an outside surface 81 at the tip 80 of each collar prong 68 has a slight inward curve.

As best illustrated in FIG. 6A, offset inward from the tip 80 of each prong 68 is a gripping step 83 forming on an inside surface S1 of each prong 68 a slight inwardly protruding annular segment 80a that is substantially parallel to the axis X when the dental device 10 is in the closed position shown in FIG. 3. Each prong 68 has an inside ledge 72 that is perpendicular to the axis X and an outside tapered wall 66. Each tapered wall 66 starts at each tip 80 of each collar prong 68 and terminates at an outer edge E5 of each gripping step 83. Each wall 66 is thicker at its junction with the gripping step 83 than at the tip 80. Similar to the walls 40 of the actuator prongs 36, the tapered wall 66 of each of the three prongs 68 each slope in a direction that forms an open mouth M2 (FIG. 5) at the end 16c of the collar 16. In this embodiment, the slope of each wall 66 is approximately 20 degrees; however, each wall 66 slopes in a direction opposite the walls 40. The open mouth M2 prior to inserting the drill bit 100 into it has a diameter that is less than the diameter of the shaft 100a of the drill bit. As the end 100b of the shaft 100a advances into the open mouth M2, this mouth opens as the end of the shaft forces the prongs 68 to flex like a leaf-spring to place the prongs in tension.

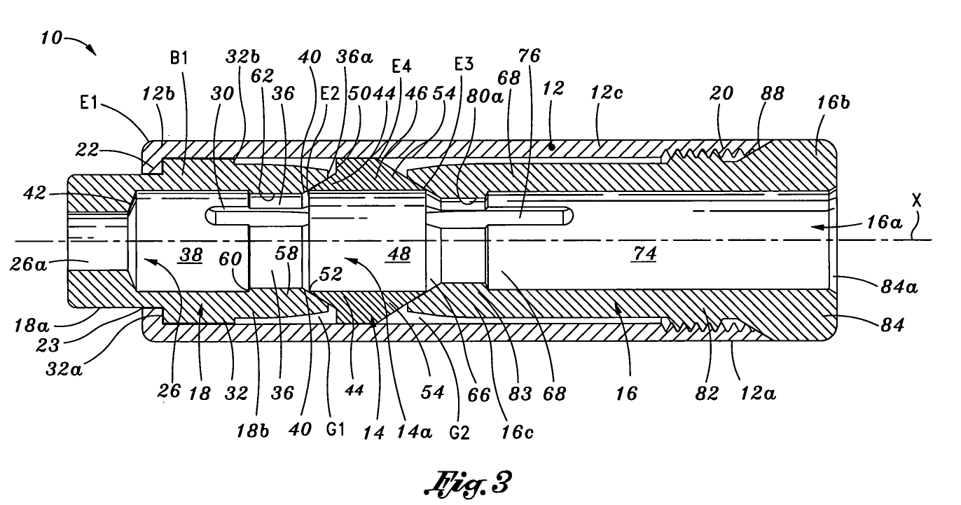

As best shown in FIGS. 5 and 6A, from an intermediate portion of the sidewall 16d where the curvature of the collar's outside surface 81 terminates, the sidewall 16d assumes a cylindrical shape that is substantially parallel to the axis X for a distance from about 0.080 to about 0.180 inch, terminating at an external threaded surface 82 of sufficient length to ensure that the collar 16 may be securely attached to the internal threaded surface 20 of the housing 12. At the end 16b of the collar 16 is a cap 84 comprising a circular protrusion having a diameter that is substantially equal to the outside diameter of the housing 12. The exterior surface of the cap 84 has a tapered bore 84a that is sloped to correspond to the sloped end 100b of the shaft 100a the housing 12 to assist in guiding the shaft into the collar 16. The cap 84 has an external diameter equal to the external diameter of the housing 12 so that when the collar 16 is secured to the housing 12 there is a smooth transition from collar 16 to housing 12, as seen in FIG. 2. The internal end 88a of the cap 16 is sloped to match the slope of the inwardly tapering annular wall 88 at the end 12a of the housing 12.

As depicted in FIG. 6A, the external curved surfaces 81 (FIG. 5) of the collar prongs 68 and the external outside surfaces 37 (FIG. 5) of the actuator prongs 36 are designed to provide sufficient space, or gaps G1 and G2, between all these prongs and the internal cylindrical surface CS of the housing 12 to enable the prongs 36 to be spread apart. In this embodiment, this requires the gaps G1 and G2 to be at least 0.006 inch between the internal cylindrical surface CS of the housing and the tips 36a and 80 respectively of actuator prongs 36 and the collar prongs 68. Also, the slope of the external surface of the receptacle spreader section 44 matches the slope of each wall 40 of each prong 36 of actuator 18, and the slope of the external surface of the collar spreader section 54 matches the slope of each wall 66 of each prong 68 of collar 16. Moreover, the collar prongs 68 are designed so that their spring strength is greater than the spring strength of the actuator prongs 36.

To assemble the dental device 10, first the actuator 18 is placed through the open end 12a of the housing 12 with the actuator's end portion 18a leading the way. The actuator's end portion 18a passes all the way through the lip opening 23 in the housing 12 until the one end 32a of the land 32 engages the internal surface of the lip 22. Next the spreader 14 is inserted into the housing 12, through the same housing end 12a, with the receptacle spreader section 44 leading the way. The spreader 14 advances along the housing 12 until the edge E2 of the receptacle spreader section 44 just rests within the mouth M1 of the actuator 18. Next the collar 16 is placed in the housing 12 with its mouth M2 facing the collar spreader section 54. The collar 16 is advanced until the edge E3 of the collar spreader section 54 just rests within the mouth M2. Then the collar 16 is twisted to engage the internal threaded surface 20 of the housing 12 and the external threaded surface 82 of the collar 16. The twisting should continue until the collar 16 is tightly attached to the housing 12, as shown in FIGS. 1 and 2. Once the collar 16 is secured to the housing 12 there is little or no pressure applied between either the collar 16 and the spreader 14 or the actuator 18 and the spreader 14.

The dental device 10 is now ready to hold the drill bit 100. For the dental device 10 to hold securely the drill bit 100, the dentist first, as shown in FIG. 6A, depresses the actuator's end portion 18a as the drill bit 100 approaches the collar's open end 16b. By depressing the actuator's end portion 18a, the actuator 18 moves along the housing 12 towards the spreader 14 to push the receptacle spreader section 44 of the spreader 14 into the mouth M1 of the actuator 18. The tapered walls 40 of the actuator 18 spread apart as this occurs, moving towards the housing's internal cylindrical surface CS to reduce or eliminate the gap G1. Because the actuator prongs 36 are less stiff, i.e., weaker than the collar prongs 68, the actuator 18 continues to move along the housing 12 while the spreader 14 remains substantially in place. As the tapered walls 40 expand outward as they move over the surface of the receptacle spreader section 44, the tips 36a of the prongs 36 eventually abut the ledge 50 of the spreader 14. This stops the movement of the tapered walls 40 along the surface of the receptacle spreader section 44 and the outward spreading of the actuator prongs 36 and begins the movement of the entire spreader 14 towards the open end 16b of the collar 16. As the spreader 14 advances towards the open end 16b, the collar spreader section 54 is pushed into the mouth M2 of the collar 16. The tapered wall 66 of each prong 68 of the collar 16 is spread apart as this occurs and moved towards the housing's internal cylindrical surface CS to reduce or eliminate the gap G2. Unlike advancing actuator 18 as the actuator's end portion 18a is manually depressed, there is no ledge 50 to halt the advancement of the collar spreader section 54 into the mouth M2 of the collar 16. Instead, the movement of the spreader 14 is stopped when the collar prongs 68 make contact with the internal cylindrical surface CS of the housing 12.

The spreading apart of the tapered walls 40 and 66 opens, respectively, the mouths M1 and M2 widely and moves all the gripping step 58 of the actuator 18 and the step 83 of the collar 18 far enough apart for the shaft 100a of the drill bit 100 to pass through each mouth. FIG. 6B illustrates that, when the actuator's end portion 18a cannot be depressed any further, the dental device 10 is ready to accept the drill bit 100. The arrows a in FIG. 6B illustrates that the actuator's end portion 18a needs to remain depressed by the dentist to keep the prongs 36 and 68 and the gripping steps 32 and 58 spread open until the shaft 100a of the drill bit 100 is completely inserted all the way into the receptacle 26 as illustrated in FIG. 6C. The drill bit 100 will be completely inserted into the receptacle 26 once its end 100b makes contact with the conical transition wall 42 of the actuator 18 as shown in FIG. 6C. With the drill bit 100 completely within the device 10, the dentist releases the actuator's end portion 18a. The potential energy stored in the flexed prongs 36 and 68 returns these prongs to a partially un-flexed state to press the gripping steps 58 and 83 firmly against the shaft 100a at spaced apart portions along the shaft 100a. Consequently, the presence of the shaft 100a of the drill bit 100 in the device 10 as illustrated in FIG. 6C prevents the prongs 36 and 68 and the gripping steps 32 and 58 from completely returning to their closed position as depicted in FIG. 3. Thus, potential energy remains stored in the prongs 36 and 68, and this stored energy is used to grip the drill bit 100 and hold it firmly in place during drilling. Because the prongs 36 and 68 cannot return to their original position, the spring action of the prongs 36 and 68 only pushes the actuator 18 partially towards the lip 22, leaving a gap G3 (FIG. 6C) between the end 32a and the lip. This gap G3 is from about 0.005 to about 0.025 inch in length. Because there are two spaced apart gripping steps 58 and 83 each holding the drill bit 100 in place, there is less precession or wobbling of the drill bit 100 when it is spinning.

As shown in FIG. 6D, once the dentist has finished using the drill bit 100 to perform the desired task, the drill bit may be easily removed from the dental device 10. To do so the dentist depresses the actuator's end portion 18a to slide the actuator 18 along the housing 12 to engage the spreader 14, thus spreading the actuator prongs 36 till they in turn push the spreader along the housing 12, which in turn spreads the collar prongs 68. Thus, just as the spreading of the prongs 36 and 68 allowed the drill bit 100 to be easily inserted, the drill bit 100 is easily removed.

The dentist may use essentially any type of drill bit or other dental tool commonly used with a dental hand-piece or drill, all of which are referred to herein as a drill bit. The shaft 100a of the drill bit 100 is depicted as cylindrical, and consequently the configurations of the receptacle 26 and passageways 14a and 16a are cylindrical. A drill bit shaft having a different cross-sectional configuration would call for the configurations of the receptacle 26 and passageways 14a and 16a to conform to this alternate cross-sectional configuration of a drill bit shaft. For example, if the cross-sectional configuration of a drill bit shaft is hexagonal, the cross-sectional configuration of the receptacle 26 and passageways 14a and 16a would be hexagonal.

### SCOPE OF THE INVENTION

The above presents a description of the best mode contemplated of carrying out the present invention, and of the manner and process of making and using it, in such full, clear, concise, and exact terms as to enable any person skilled in the art to which it pertains to make and use this invention. This invention is, however, susceptible to modifications and alternate constructions from that discussed above which are fully equivalent. Consequently, it is not the intention to limit this invention to the particular embodiments disclosed. On the contrary, the intention is to cover all modifications and alternate constructions coming within the spirit and scope of the invention as generally expressed by the following claims, which particularly point out and distinctly claim the subject matter of the invention:

1. A dental device for holding a dental drill bit including
a housing having an axial, substantially cylindrical passageway extending between first and second opposed open ends of the housing,
a substantially cylindrical actuator member, a substantially cylindrical collar member, and a spreader member, said actuator member, collar member and spreader member being substantially axially aligned within the housing passageway with the spreader member between the actuator and collar members and the collar member fixedly attached to the housing and the actuator and spreader members being moveable axially,
said spreader member having a substantially cylindrical axial passageway extending between opposed open ends thereof and first and second opposed external tapered wall sections slanting towards each other,
said collar member having an axial passageway extending between opposed outer and inner open ends of the collar member with the collar member inner open end proximate the first tapered wall section, said collar member including a flexible and resilient wall segment forming a spring mechanism having a predetermined strength, said collar member wall segment having a first position that restricts the collar member passageway to prevent a drill bit from passing through said collar member passageway and a second flexed position that expands the collar member passageway to allow a drill bit to pass through said collar member passageway,
said actuator member having an axial receptacle therein terminating in an inner open end proximate the second tapered wall section, said actuator member including a flexible and resilient wall segment forming a spring mechanism having a predetermined strength that is less than the strength of the collar member spring mechanism, said actuator member wall segment having a first position that restricts the actuator member receptacle to prevent a drill bit from extending substantially into the receptacle and a second flexed position that expands the receptacle to allow a drill bit to extend substantially into the receptacle,
said actuator member having its outer end projecting outward from the second end of the housing to enable said actuator member to be manually pushed into the housing to advance the actuator member inward a predetermined distance to engage the inner end of the actuator member and the second tapered wall section to move the actuator wall segment into the second position to expand the receptacle to allow a drill bit to be inserted therein and to advance the spreader member to engage the inner end of the collar member and the second tapered wall section to move the collar member wall segment into the second position to expand the collar member passageway to allow a drill bit to be inserted through the passageways of the collar and spreader members and into the receptacle,
upon release of the actuator member with a drill bit inserted therein, the spring mechanism of the collar member first pushes the spreader member and the actuator member towards the second end of the housing with the collar member wall segment bearing against one portion of an inserted drill bit and then the spring mechanism of the actuator member pushes the actuator wall segment to bear against another portion of an inserted drill bit and further advances the actuator member towards the second end of the housing, whereby an inserted drill bit is held firmly in the device.

2. The dental device of claim 1 where the wall sections of the spreader member are each have substantially truncated conical configuration.

3. The dental device of claim 2 where the outer peripheral end of first wall section terminates at the internal surface of the housing passageway and the outer peripheral end of the second wall section is offset inward from said internal surface to form a step in the spreader member.

4. The dental device of claim 1 where each said tapered wall section has an outer peripheral end terminating at or near an internal surface of the housing passageway and forming an acute angle with respect to said internal surface, said acute angles formed between the wall sections of the spreader member and the internal surface of the housing passageway being from 10 to 30 degrees.

5. The dental device of claim 1 where the actuator member includes a stop element that engages an end wall at the second end of the housing to prevent the actuator member from being withdrawn from said second end of the housing.

6. The dental device of claim 5 where the stop element comprises a substantially annular land that forms a step in advance of the outer end of the actuator member, said land abutting said end wall when said actuator member wall segment is in the first position.

7. The dental device of claim 6 where the annular land has an outside diameter substantially equal to the diameter of the housing passageway.

8. The dental device of claim 1 where the collar member is detachably connected to the first end of the housing.

9. The dental device of claim 1 where said predetermined distance is from 0.010 to 0.040 inch.

10. The dental device of claim 1 where the diameter of the housing passageway is from 0.10 to 0.115 inch.

11. The dental device of claim 1 where the spreader member has an annular outside diameter substantially equal to the diameter of the housing passageway.

12. The dental device of claim 1 where the passageway in the spreader member has a diameter that is substantially equal to the diameter of a drill bit to be inserted there through.

13. The dental device of claim 1 where the passageway in the collar member has a diameter that is substantially equal to the diameter of a drill bit to be inserted there through.

14. The dental device of claim 1 where the receptacle has a diameter that is substantially equal to the diameter of a drill bit to be inserted therein.

15. A dental device for holding a dental drill bit including
a housing including an elongated passageway,
a gripping mechanism within the passageway adapted to releasable retain a drill bit, said gripping mechanism including a pair of spaced apart holding members along the passageway that each grasp an inserted drill bit to apply a gripping force to an inserted drill bit at two spaced apart locations along the drill bit to avoid or minimize precession of the drill bit during rotation of the dental device,
said gripping mechanism having a first position that prevents a drill bit from extending substantially into the passageway and being grasped by said holding members and a second position enabling a drill bit to extend substantially into the passageway and be held by said holding members, and
a spring biased actuator member at least partially within the housing passageway, said actuator member having a portion thereof enabling manual actuation to advance the actuator member in a first direction into the passageway to move the gripping mechanism between the first and second positions, and upon release, said actuator member moving in a second direction opposite the first direction by spring action.

16. The dental device of claim 15 where each holding member includes a flexible and resilient wall segment forming a spring mechanism having a predetermined strength.

17. The dental device of claim 16 where the spring strength provided by one holding member is less than the spring strength of the other holding member.

18. The dental device of claim 17 including a spreader member between the holding members that actuates the spring mechanisms of the holding members as the actuator member is advanced.

19. The dental device of claim 18 where the spreader member has an axial passageway extending between opposed open ends thereof and first and second opposed external tapered wall sections slanting towards each other, each said tapered wall section having an outer peripheral end terminating at or near an internal surface of the housing passageway and forming an acute angle with respect to said internal surface.

20. A dental device for holding a dental drill bit including
a housing having an axial passageway therein,
a spreader member having an axial passageway,
an actuator member having an axial receptacle and a wall segment that functions as a leaf spring,
a collar member fixedly attached to the housing and having an axial passageway and a wall segment that functions as a leaf spring,
said spreader, actuator, and collar members being axially aligned within the housing passageway and said actuator and spreader members being moveable along the housing passageway between a first position where the wall segments prevent substantial insertion of a drill bit into the dental device and a second position where the wall segments are flexed to expand the passageways of the actuator and collar members to allow a drill bit to be inserted into the device,
said actuator member having a portion enabling manual actuation thereof to move said actuator member between the first and second positions, said actuator member upon being released said flexed wall members move towards their first positions.

21. The dental device of claim 20 where the wall segment of the collar member has a predetermined strength and the wall segment of the actuator member has a spring strength that is less than the collar member predetermined spring strength.

22. The dental device of claim 21 where the spreader member has first and second opposed external tapered wall sections slanting towards each other, each said tapered wall section having an outer peripheral end terminating at or near an internal surface of the housing passageway and forming an acute angle with respect to said internal surface.

23. A dental device for gripping a dental drill bit including
a hollow housing member having opposed open ends, one end having a restricted opening therein formed by a lip member at said one end,
a collar member extending into said housing and having a passageway there through with an external end into which a drill bit is inserted and an internal expandable end that prevents the passage of an inserted drill bit unless expanded,
an axial moveable actuator member extending into said housing and having a stop member limits the axial movement of the actuator member in one direction,
said actuator member having an end portion that fits through the restricted opening and a receptacle member adapted to receive an inserted drill bit that has an expandable end portion that prevents insertion of an inserted drill bit unless expanded, and
a spreader member having opposed surfaces and a passageway that allows an inserted drill bit to pass freely there through, said surfaces interacting with the actuator member and collar member when the actuator is manually depressed to expand the internal expandable end of the collar member and to expand the expandable end portion of the receptacle member.
